(19) United States
(12) Patent Application Publication
(10) Pub. No.: US 2005/0219238 A1
(43) Pub. Date: Oct. 6, 2005

(54) Planar reformat internal surface viewer

(76) Inventor: Hubrecht Lambertus Tjalling De Bliek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/521,289

(22) PCT Filed: Jun. 25, 2003
(86) PCT No.: PCT/IB03/02723

§ 371 Date: Jan. 14, 2005

(30) Foreign Application Priority Data
Jul. 16, 2002 (EP) 02077855.1

(51) Int. Cl. G06T 15/00; G06T 17/00

(52) U.S. Cl. 345/419; 345/424

(57) ABSTRACT

A method for displaying reformatted slices relative to selected points on an object surface is described. An initial point on the surface is selected, a depth is selected relative to the surface and a reformat slice is calculated at this depth. Further reformat slices are calculated for further points selected on the surface. Reformat slices may be displayed at an angle perpendicular to the normal to the surface at th e surface point selected. The depth may be chosen using multi-planar reformats calculated along this normal, using information transverse to the normal or using a priori information.

The invention relates to the production and displaying of a volume from a multi-dimensional object data set. This is used in medical imaging but also occurs in other endeavours such as archaeological research, computer assisted training and anywhere where image analysis of volumes is undertaken.

The technical field of medical imaging offers the clinician many opportunities to see images of the internal anatomy or structure of a subject. Modem imaging and image reconstruction methods allow accurate and reliable visualization of internal structures from both planar and tomographic perspectives and allow image data to be manipulated so that structures can be viewed in a variety of information enhancing ways.

In short, the clinician or user is offered a variety of scope for extracting relevant information from any body or set of acquired data.

A physical object can be imaged by any one of a variety of methods and described in information space by an object data set, a collection of stored data points which contain information about physical characteristics of the real object. These physical characteristics may be X-ray opacity or water content for example, depending on the imaging modality used to perform the scan. The resulting data points can be manipulated by a variety of known techniques to produce images of the original object and to produce varying technical results in these images. For example, the data may be used to show the object from different angles rendered in 3 dimensions using space filling volume rendering techniques, or shown in 2 dimensional slices in which image data along a plane within the original object is displayed.

Two dimensional slices may further be constructed at any angle within the object data set. This is usually achieved using the techniques of multi-planar reformatting. Multi-planar reformatting is a method by which image data, often already acquired in transverse planar sections due to the limitations of the imaging modality, can be viewed from any angle or direction. To achieve this a reference direction is often selected within the object data set and the image data is reconstructed into a stack of 2 dimensional slices perpendicular to that direction and encompassing or derived from the data contained in the object data set. Stacks of such 2 dimensional images can in principle be reconstructed for any direction chosen by the user.

It is not necessary for every 2 dimensional image in the stack to be shown or even to be created and methods exist whereby a single planar reformat can be calculated from a data set containing 3 dimensional volume data. Indeed, the reformat does not even need to be planar and can in principle be curved along one or more dimensions, or can take any shape.

Other techniques known to those skilled in the art include identifying the surfaces of objects within the overall image volume, identifying the normals to those surfaces at all points and identifying sub-volumes which correspond to structures within the real object.

A method of producing and displaying an image of a volume from a multi-dimensional object data set is known from U.S. Pat. No. 5,986,662 which discloses a computerized system for viewing voxel data on a display device. It allows the user, usually a clinician, to create and handle volume rendered images from an object data set comprising patient image data. Within the system the user can select images, fly through or around them, pan and zoom over images, change slices, toggle between orthogonal and oblique views and manipulate visual attributes within the images such as color and transparency value. In particular the system allows users to create and view multi-planar reformat images (MPRs) reconstructed from the original object data set. However, existing limitations of MPRs are not alleviated by the system. MPRs are reconstructed in stacks and although the handling of each individual image is facilitated, the viewing of multiple slices from different stacks is still laborious.

It is an object of the invention to offer the user another way of viewing image data taken from an object data set. This is achieved according to the method of our invention which is characterized in that
a surface associated with the volume is identified,
an initial position on the identified surface is selected,
at least one depth associated with the identified surface is selected,
a reformat slice is produced from the object data set at the selected depth along the normal to the identified surface at the selected position.

In the method according to the invention, the surface of an imaged object or volume is identified and displayed to the user. The identification may be performed using known methods, for example, by ray casting. An image of the surface is displayed to the user on a viewing screen and an initial position selected on this displayed, identified surface. This selected position may be initially selected by the user or may also be selected automatically by computer.

A depth is then selected. This depth corresponds to a distance below the identified surface along the normal to the surface at the point at which the selected position is chosen. It corresponds to a point within the object data set and therefore corresponds to a real depth below the surface of the real object originally imaged.

A reformat is then created and displayed at this depth below the selected position on the identified surface. This may be a planar reformat but may also be a curved reformat. The user is thereby given a view of the real object, described by the object data set, at this depth below the identified surface which itself corresponds to the real surface.

This reformat may be calculated and displayed at any angle relative to the normal to the surface. If it is a planar reformat it might usually be calculated at an angle that renders it perpendicular to the normal to the surface, as this will give a view analogous to that which would be seen by the viewer if he or she were able to strip away the surface and outer layers of the object down to the selected depth and view the substructure by facing it directly. However, it may also sometimes be advantageous to view the reformats at other angles when the underlying anatomy renders some other orientation more beneficial.

The method as described can be extended to other points on the selected surface. In this case, once the depth has been selected, a planar reformat can be created and displayed for each position on the identified surface that is subsequently selected. This occurs without any further selection or reselection of the depth, this depth having already been selected when the initial reformat was created. Again, subsequent reformats may or may not all be perpendicular to the normal to the surface at the selected points.

The chosen depth below the identified surface at which the planar reformats are created and displayed can be calculated or selected in a number of ways. For example, following the selection of the position on the surface, and the inherent identification of the normal to this surface, a stack of multi-planar reformats, or MPRs, can be created along this normal. The user of the system may then view these MPRs until one is identified which provides the user with such information as is useful and interesting. The user can then select the particular MPR slice at the depth which shows this information and in doing so select that particular depth relative to the identified surface.

Alternatively, having selected the position on the surface, the user may be presented with an image showing information which is transverse to the surface at the selected position. In this instance the user sees a cross-sectional view through the object including the surface and any structures embedded within the object. Within the confines of this image, the user can select a depth with respect to the identified surface. The physical process of selection may be undertaken by a mouse click or by, say, the entering of coordinates, if these are provided for within the image. The depth may also be automatically selected from within the lateral image using feature detection. That is to say, a system capable of automatically identifying structures of interest lying within the plane of an image is used to identify the surface of the object and the structure to be viewed using the invention. The depth is then automatically identified and selected as the perpendicular distance between the identified object and the surface of the object.

As another alternative, the depth may be entered into the image handling system without regard to the images. This situation may occur for example, when there is a priori knowledge of the object or class of objects represented by the object data set. In this case, the depth at which some substructure lies beneath the surface of the image may already be known.

It can be seen that the method so described allows the user, having once selected an initial position and a relative depth, to view a succession of image data, at that fixed, selected depth, below the already identified surface of an object, for all subsequently selected positions on that surface. As such, the invention allows the viewer to skim under the surface, viewing image data which is always at a position directly along the normal line relative to each point on the identified surface. This is highly advantageous when an object of interest resides within the volume and is positioned in such a way that some aspect of the object is always at the same depth relative to an identifiable surface. This aspect may be a separate inner surface within a volume, or may be the surface of some object residing within the volume. As such the method can be seen to be particularly useful if the structure to be viewed is at approximately the same depth below the identified surface of a volume. The viewer is then allowed a succession of images which contain visual information about that object at the selected depth below the identified surface of the overall object. As an example of this, the curved surface of an artery lying at a constant depth below the skin surface may be viewed if curved reformats encompassing the curvature of the artery are calculated and displayed for all positions along the surface of the object which track the position of the artery. For all such positions chosen, the reformats, as displayed on a 2 dimensional viewing screen, will show the information held in the curvature of the artery opened out into 2 dimensions.

It is now seen that it may be advantageous to present the planar reformatted views at angles other than 90° to the normal to the identified surface at each successive position selected on that surface. The orientation of the structure which is visible under the identified surface of the volume may vary throughout the volume and so it may be advantageous to reconstruct planar reformats at some angle other that 90° which more usefully presents visual information about the structure under consideration.

These and other aspects of the invention will be further elucidated and described with reference to the drawings.

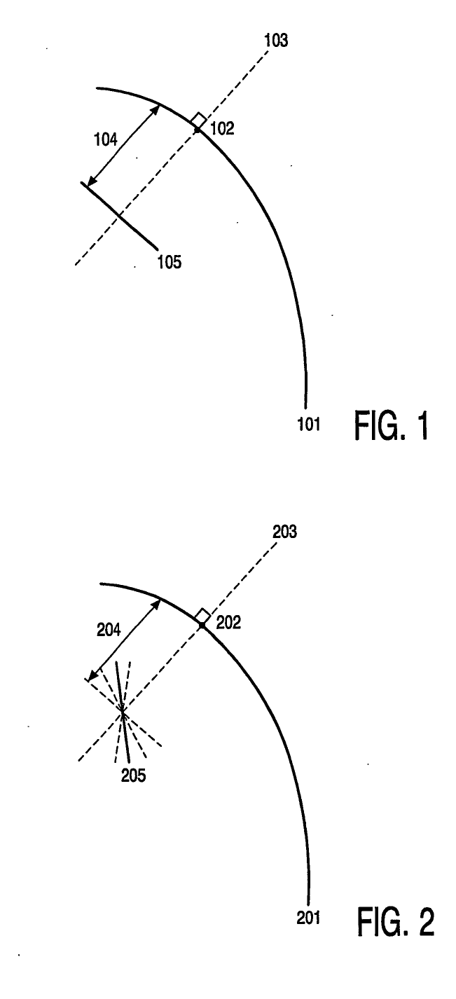

FIG. 1 shows a feature of the invention.

FIG. 2 shows the planar reformat produced at different angles to the normal, as may be applicable in the use of the invention.

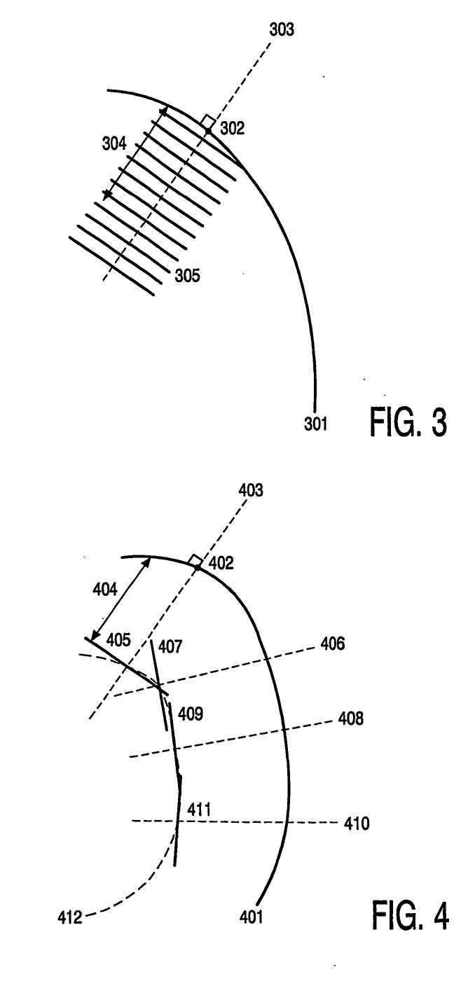

FIG. 3 shows the selection of the depth using multi-planar reformats, as described in the invention.

FIG. 4 shows the extension of the technique of the invention to further selected positions on the identified surface.

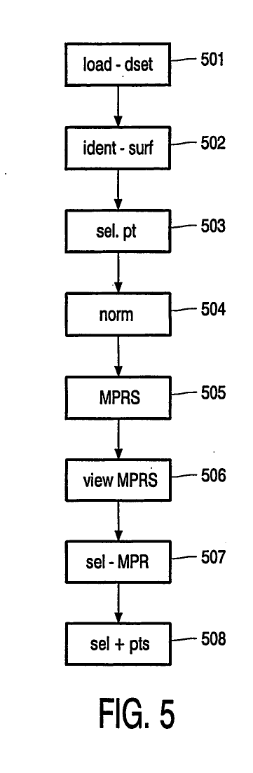

FIG. 5 shows a flow diagram by which the invention may be used in practice.

A feature of the invention is shown in FIG. 1, which indicates the identified surface 101 of an object described by an object data set. An initial point 102 is selected on the surface and the normal to the surface at this point 103 is calculated. A depth 104 below the surface along the normal at this point is selected and a planar reformat of the image data 105 produced at this depth.

FIG. 2 shows planar reformat reconstructed at different angles and shows the same surface 201, selected position 202, normal to the surface 203 and depth 204. However now the planar reformat 205 is shown produced at a number of angles not equal to 90°.

FIG. 3 shows the selection of the depth using multi-planar reformats. Once the surface 301 and the position 302 are selected and the normal 303 produced, a stack of MPRs 305 are produced. The user is then free to search through these until one is found which shows the information of interest. This MPR slice is then selected and in doing so the depth at which that selected MPR is situated is now used as the selected depth.

FIG. 4 shows the extension of the technique of the invention to further selected points. Once the surface 401 and initial position 402 have been selected, the normal 403 produced and a depth 404 selected with the corresponding planar reformat slice 405, an planar reformat at the same depth 407, 709, 411 can be produced for all further selected points 406, 408, 410. In doing so it can be seen that planar reformat slices sweep out for the viewer an image of a surface 412 defined below the originally identified surface 401 in the object data set.

In effect, the viewer is presented with images taken from a secondary surface within the original object. The invention as described is particularly useful for viewing surfaces within objects. Just such a surface is the surface of the cortex of the brain and a potential embodiment for viewing the cortex of the brain is described in FIG. 5.

An object data set including 3 dimensional information describing a head is loaded 501, load-dset, and the surface of the head identified and shown on the visual display 502, ident-surf. The user then selects a point on this surface 503, sel−pt, and the normal to the identified surface is calculated at that selected point 504, norm. A stack of MPRs are then produced along this normal, 505 and these are then viewed by the user, 506. One of these NTRs is selected 507 and the depth at which this slice was produced is stored. The user is then free to select further points on the surface of the head 508, sel+pts and for all such further points the user is presented with an image of a reformatted slice at the stored depth and directly below the further selected point.

In practice this motion of further point selection would be more fluid. In an embodiment of the invention the user, having selected an initial depth, would then move the cursor on the viewing screen over the displayed surface and be presented with an equivalent planar reformat for every point on the identified surface that the cursor had traversed across. By the very nature of the display process the viewing screen would be required to display different features. So, for example, part of the display screen would show an image of the surface and part would show the resultant reformats created for each cursor position. As the cursor moved over the displayed surface in one part of the screen, the reformat view would change to show the calculated reformat for each position of the cursor.

Although the identified surface of the object is necessary for the calculation of the surface normal, the invention can be achieved without the display of this surface. For example, once an initial position is selected and the mouse dragged, every subsequent position relative to the initial position can be calculated as a function of the amount of mouse movement. The initial position can be selected from, for example, three orthogonal multi-planar reformats and even though the surface is not displayed, an additional reformat can be calculated for every subsequent position as long as the surface is known, i.e. the group of all points which form the surface are known.

Although this embodiment describes the invention as applied to a head, advanced volume visualization techniques allows the identified surface to reside anywhere within a volume. For example, an object data set describing a torso may be used and a kidney within the abdomen segmented. The technique can then be applied to the kidney, so that the surface of the kidney medulla could be viewed. The user will, upon understanding the invention, be able to provide many more examples.

1. Method of producing and displaying an image of a volume from a multi-dimensional object data set, characterized in that:
a surface associated with the volume is identified,
an initial position on the identified surface is selected,
at least one depth associated with the identified surface is selected,
a reformat slice is produced from the object data set at the selected depth along the normal to the identified surface at the selected initial position.

2. A method as in claim 1, characterized in that:
at least one further position on the identified surface is selected and a reformat slice is produced at said selected depth along the normal to the identified surface at said further selected position.

3. A method as in claim 1, characterized in that:
reformat slices are produced perpendicular to the normal to the identified surface at the selected position, and
the depth associated with the identified surface is selected by selecting one of those reformat slices.

4. A method as in claim 1, characterized in that:
a transverse view is created, which includes the identified surface and the selected point, and
the depth associated with the identified surface is selected from this transverse view.

5. A method as in claim 1, characterized in that:
the depth associated with the identified surface is selected from a priori information.

6. A method as in claim 1, characterized in that:
the reformat slice is perpendicular to the normal to the identified surface at the selected point on the identified surface, at the point on the reformat slice where the reformat slice is intersected by said normal to the identified surface.

7. A method as in claim 1, in which reformat slices are produced along the normal to the identified surface at the selected position, characterized in that:
the reformat slice is produced from a stack of reformat slices produced perpendicular to the normal to the selected point on the surface.

8. A computer program characterized in that:
the computer program contains instructions to enable a surface associated with the volume to be selected, instructions to enable an initial point on the identified surface to be selected, instructions to enable at least one depth to be selected and instructions to enable a reformat slice to be produced from the object data set at the selected depth along the normal to the identified surface at the selected position.

9. A workstation configured for the purposes of producing, displaying and using images and containing instructions for the production and display of an image of a volume from a multi-dimensional object data set, characterized in that:
the workstation further includes instructions to enable a surface associated with the volume to be selected, instructions to enable an initial point on the identified surface to be selected, instructions to enable at least one depth to be selected and instructions to enable a reformat slice to be produced from the object data set at the selected depth along the normal to the identified surface at the selected position.
